(19) United States
(12) Patent Application Publication
(10) Pub. No.: US 2013/0065202 A1
(43) Pub. Date: Mar. 14, 2013

(54) Method for designing test to assess skills for computer programming

(71) Applicant: Yue Zhang, Surrey (CA)

(72) Inventor: Yue Zhang, Surrey (CA)

(21) Appl. No.: 13/232,846

(22) Filed: Sep. 14, 2011

(51) Int. Cl. G09B 19/00

(52) U.S. Cl. 434/118

(57) ABSTRACT

This invention provides a method to design assessment tests for computer programming skill. Presently there are several tests like Microsoft and Java Certification. However, all the tests are not well designed and cannot provide accurate measure of genuine programming skills of testees. A good test for programming skill must have testee do the actual programming during the test. This invention is aimed at allowing testee to do the actual programming in tests while results can be graded by machine automatically. This is achieved by having questions in tests specially designed so that testee can only answer multiple-choice questions correctly if he makes the computer programs running correctly. The embodiment of this invention makes it implemented in various fields of Microsoft .Net and C# programming language and obviously applied to other languages.

### BACKGROUND OF THE INVENTION

1. Field of the Invention

The present invention relates to assessment tests for computer programming skill, in particular, to design assessment tests wherein testee can do the actual programming while the results can be graded by machine automatically without manual effort being involved.

2. Description of the Related Art

Presently there are several assessment tests such as Microsoft Certification, Java Certification, Previsor and etc. However, all the tests only provide multiple choice questions for testee to answer. Testee does not do the actual programming in the tests. As the result, testee without good programming skill can often achieve good scores by more rehearsal. On the other hand, a good programmer can get bad marks for less rehearsal and not used to the type of questions in the tests. This deficiency greatly reduces the credibility of test results, and can not provide a consistent and accurate measure of the genuine programming skill of testee. A good test for programming skill must have testee do the actual programming during the test. Perhaps the fact that computer program is hard to be graded by machine, and the belief that manual effort must be involved in the grading process of such tests, together with the high cost, long duration and inconsistency of manual grading, cause this problem.

### SUMMARY OF THE INVENTION

This invention is aimed at overcoming this deficiency by allowing testee to do the actual programming in assessment tests while the results can be graded by machine automatically. This is achieved by having questions in tests specially designed so that testee can only answer multiple choice questions correctly if he makes the computer programs running correctly. Furthermore, tests are open book and conducted in an environment very close to that of actual programming. As the result, programmer with good skill and rich experience can get high marks with minimum preparation. Test scores can not be easily improved by rehearsal and better reflect true programming skill.

The embodiment of this invention makes it implemented in various fields of Microsoft .Net and C# programming language. In addition, this method can be obviously applied to other major programming languages such as VB.Net, C, C++, PHP, Java, Objective-C, and etc.

The assessment test should be conducted on an administered testing site to eliminate any chance of cheating. Testee is provided with a computer on which test materials and questions are found. The test is open book in order to simulate actual programming environment. But testee must complete it without any kind of help from others. As the result, web access with browsers is available, but E-mail, chat, smart phone or any other contacts with outside are not allowed. Testee is also provided with a software development tool (IDE) to do the programming. For example, Visual Studio is provided for those who take test on Microsoft .Net and C# programming language. All questions in the test are multiple choice questions that consist of 4 choices. Testee will select one best answer to the question. There is no penalty for wrong answer.

### BRIEF DESCRIPTION OF THE DRAWINGS

The novel features and advantages of the invention will be apparent from the more detailed description of preferred embodiments of the invention, as illustrated in the following drawings.

FIG. 1 illustrates 1st part of test questions for C# operators, array and stream reader class.

FIG. 2 illustrates 2nd part of test questions for C# operators, array and stream reader class.

FIG. 3 illustrates 1st part of test questions for C# file, directory and FTP classes.

FIG. 4 illustrates 2nd part of test questions for C# file, directory and FTP classes.

FIG. 5 illustrates 1st part of test questions for C# HTTP and stream classes.

FIG. 6 illustrates 2nd part of test questions for C# HTTP and stream classes.

FIG. 7 illustrates 1st part of test questions for C# Image and Bitmap classes, image editing and saving, C# array and operators.

FIG. 8 illustrates 2nd part of test questions for C# Image and Bitmap classes, image editing and saving, C# array and operators.

FIG. 9 illustrates 3rd part of test questions for C# Image and Bitmap classes, image editing and saving, C# array and operators.

FIG. 10 illustrates test questions for C# file decryption and string operation.

FIG. 11 illustrates 1st part of test questions for Windows form code, designer and controls.

FIG. 12 illustrates 2nd part of test questions for Windows form code, designer and controls.

FIG. 13 illustrates 1st part of test questions for ASP.Net code, designer, controls, SQL server, ADO.Net and gridview.

FIG. 14 illustrates 2nd part of test questions for ASP.Net code, designer, controls, SQL server, ADO.Net and gridview.

FIG. 15 illustrates 3rd part of test questions for ASP.Net code, designer, controls, SQL server, ADO.Net and gridview.

FIG. 16 illustrates 4th part of test questions for ASP.Net code, designer, controls, SQL server, ADO.Net and gridview.

FIG. 17 illustrates 1st part of test questions for WCF service.

FIG. 18 illustrates 2nd part of test questions for WCF service.

FIG. 19 illustrates 1st part of test questions for Silverlight code, designer, controls, Silverlight datagrid, Linq to SQL.

FIG. 20 illustrates 2nd part of test questions for Silverlight code, designer, controls, Silverlight datagrid, Linq to SQL.

### DETAILED DESCRIPTION OF THE EMBODIMENTS OF THE INVENTION

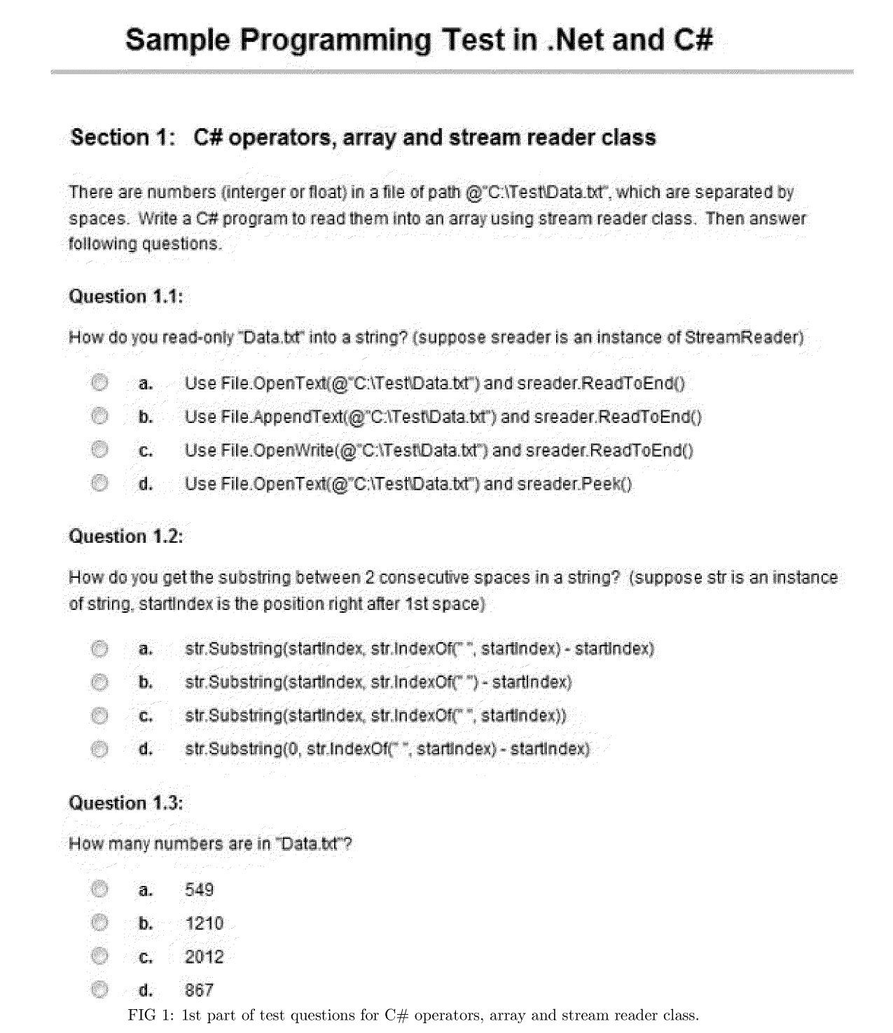

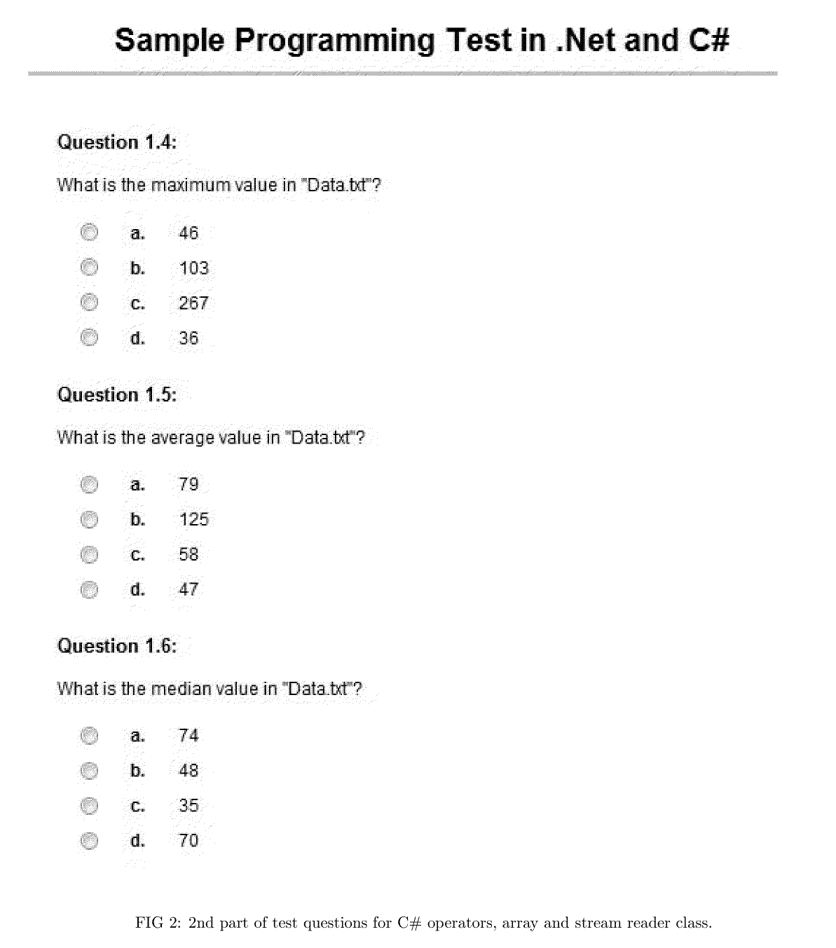

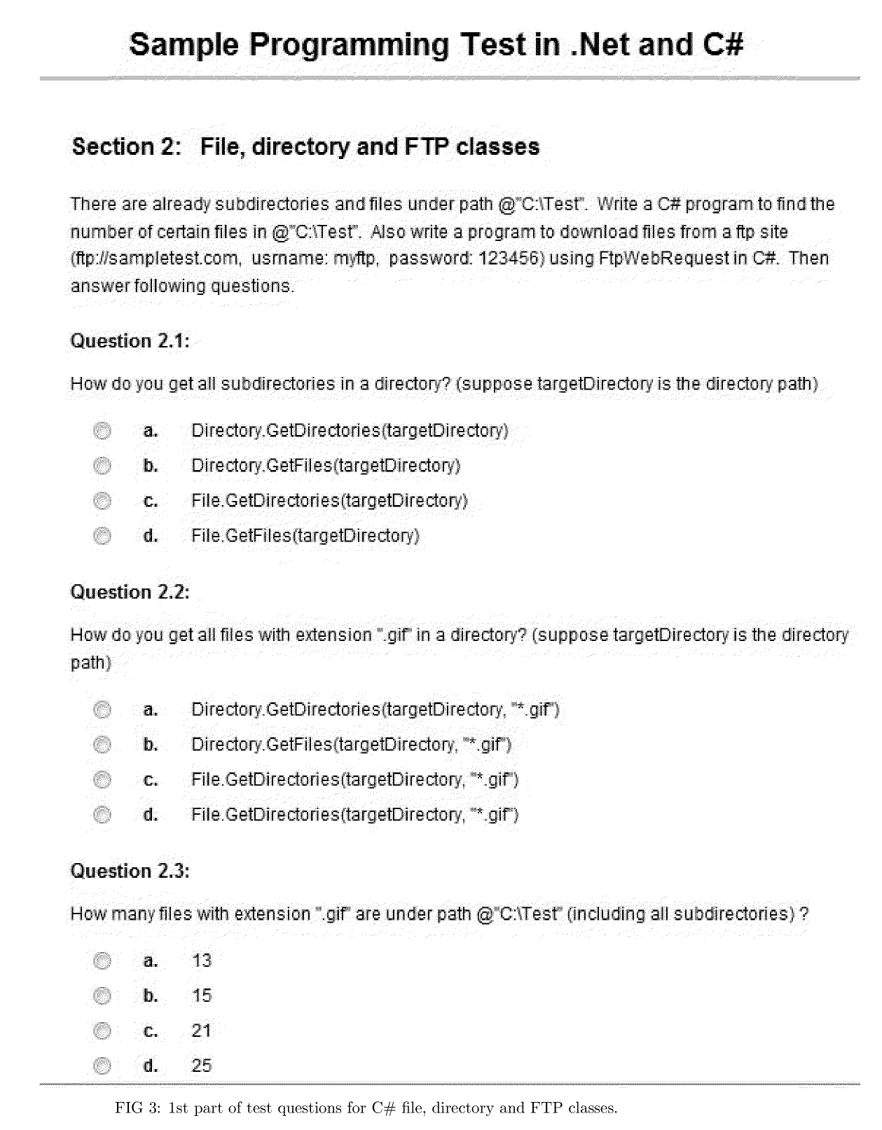

Questions in Section 1 test the programming skill in C# operators, array, file and stream reader classes. In order to convert data from a file to an array, testee has to be familiar with System.IO.File, System.IO.StreamReader and System.String Classes. First data in the file is read into a string by File.OpenText and StreamReader.ReadToEnd methods. Second substrings between 2 consecutive spaces in the string are obtained and converted to numerical type and stored in an array. This completes questions in FIG. 1. To answer questions in FIG. 2, testee must be familiar with C# arithmetic, conditional and other operators to calculate the maximum, average and median values for the array. In order to answer the questions correctly, testee must write an actual program in C# and get it running correctly.

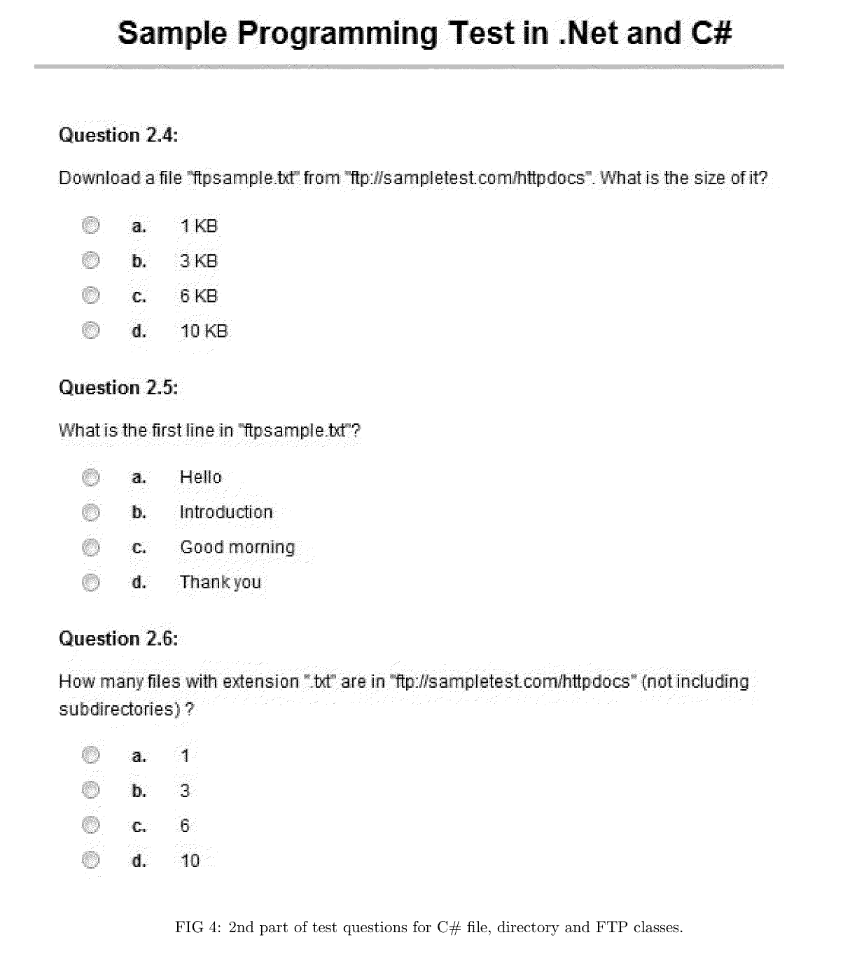

Questions in Section 2 test the programming skill in C# file, directory and FTP classes. To answer questions in FIG. 3, testee must be familiar with System.IO.File, System.IO.Directory, array, for loop, recursive method and etc. Directory.GetDirectories and Directory.GetFiles methods must be used to get all files with certain extension and all subdirectories in a directory. A recursive algorithm is required to loop through all the subdirectories. To answer questions in FIG. 4, testee must be familiar with System.Net.FtpWebRequest class. A NetworkCredential is needed to be created and FtpWebResponse.GetResponseStream is used to download files from FTP site.

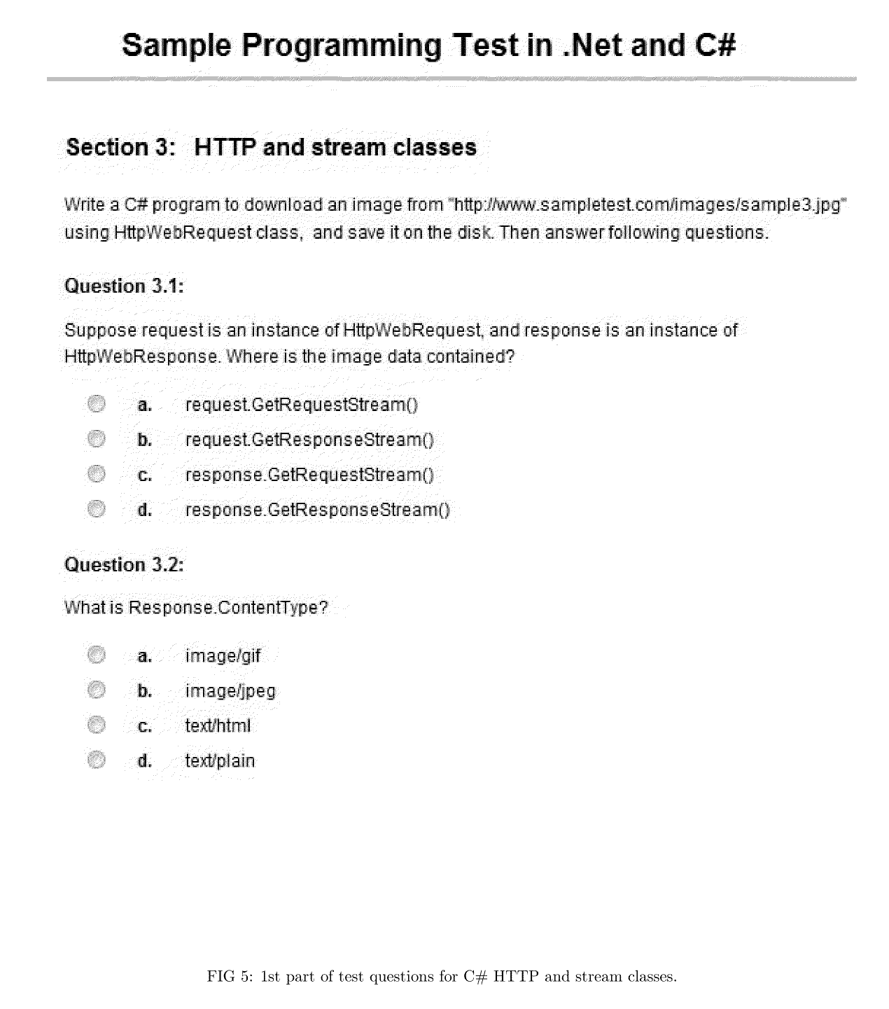

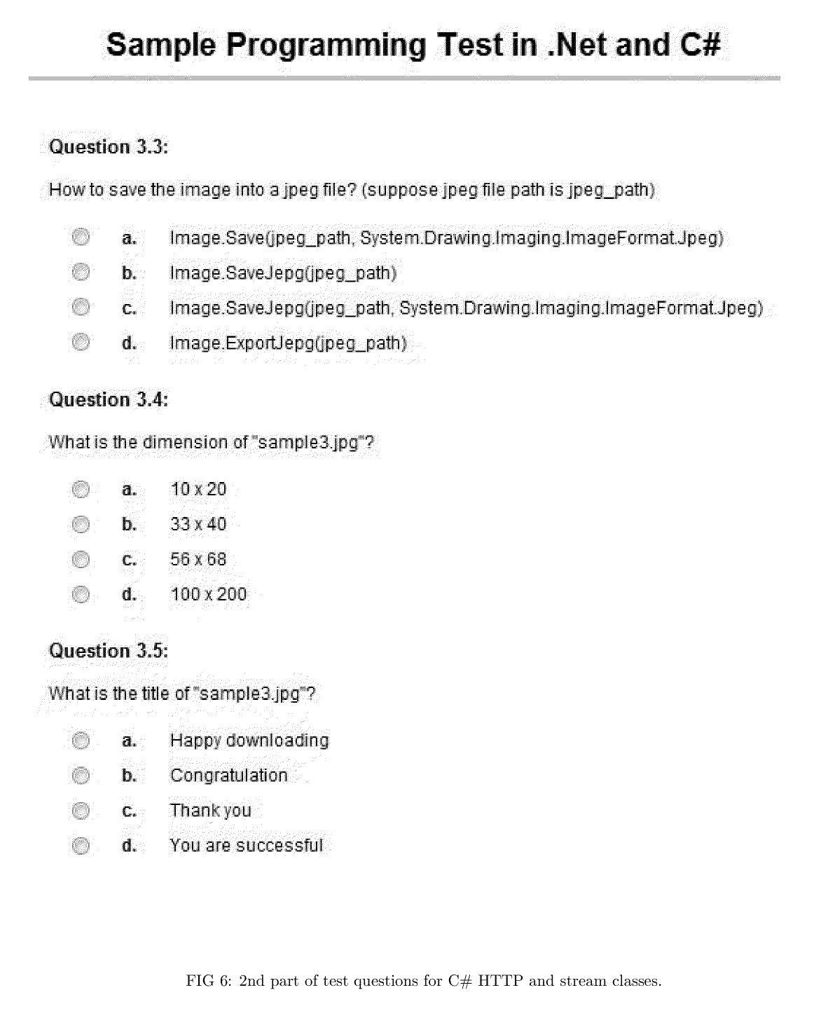

Questions in Section 3 test the programming skill in C# HTTP and stream classes. Analogous to that of Section 2, testee must be familiar with System.Net.HttpWebRequest and HttpWebResponse classes, and GetResponseStream method, and an image must be downloaded correctly in order to answer questions in FIGS. 5, 6 correctly.

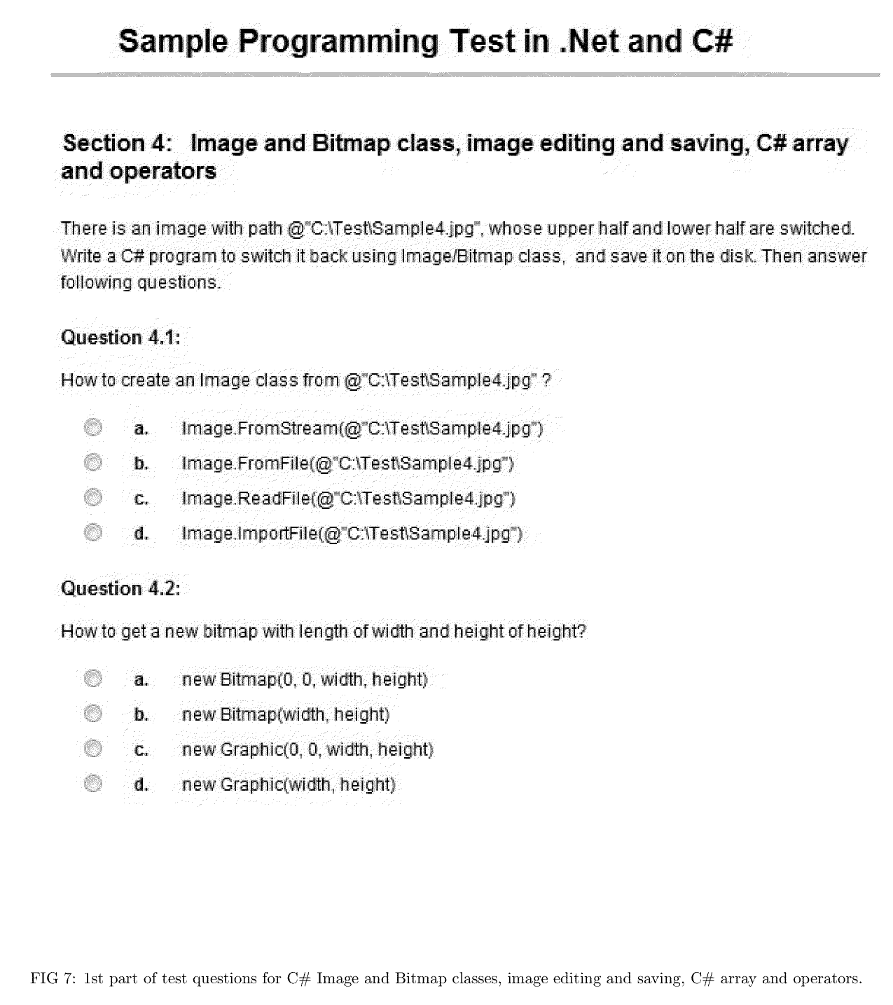

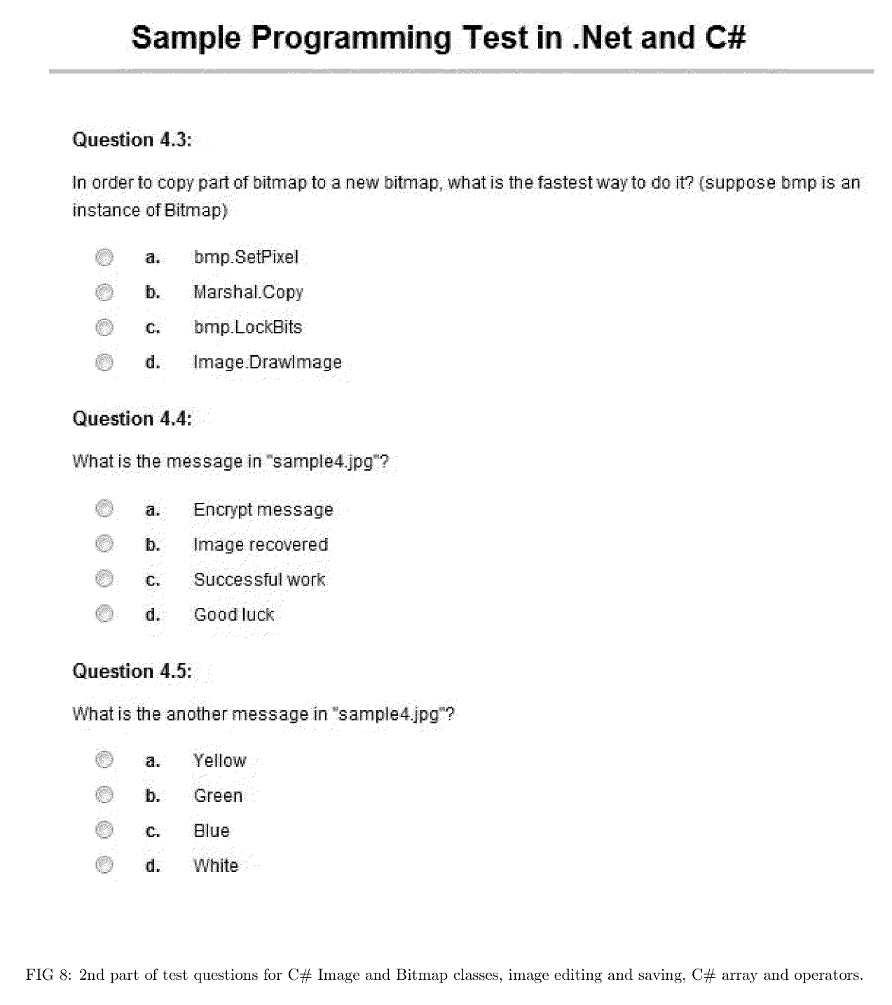

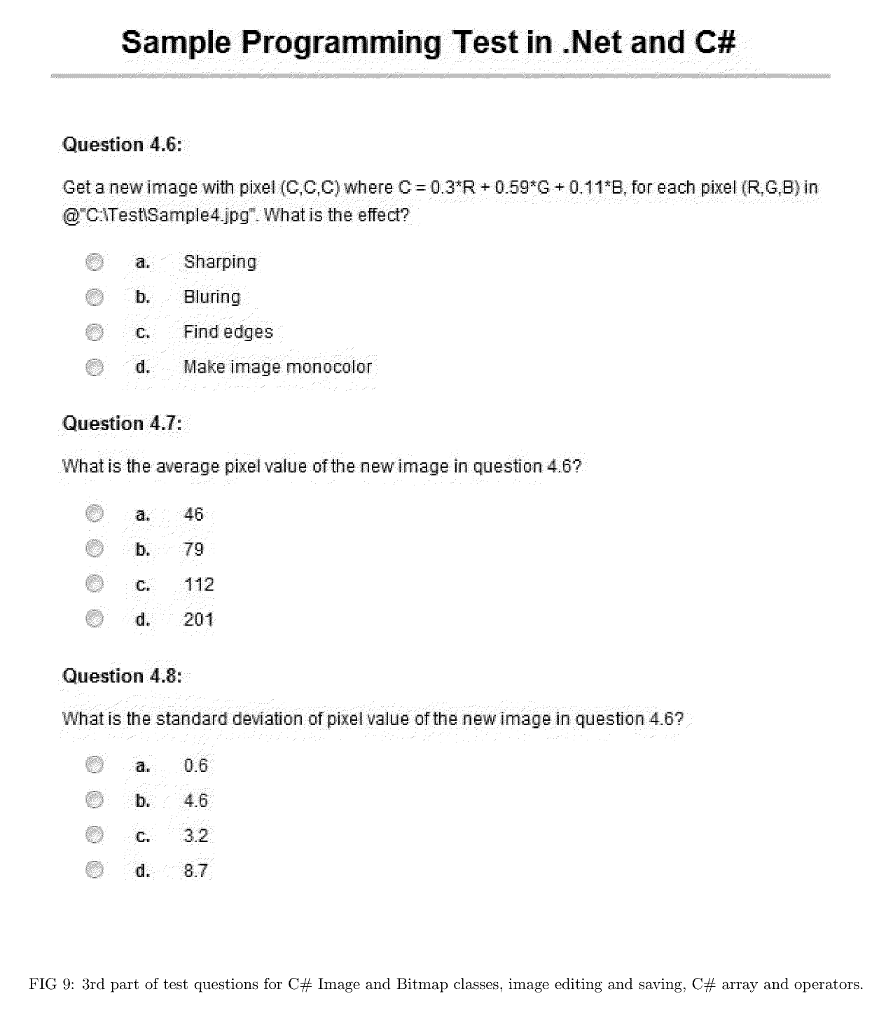

Questions in Section 4 test the programming skill in C# Image and Bitmap classes, image editing and saving, array and operators. To answer questions in FIGS. 7 and 8, testee must be familiar with System.Drawing.Image and System.Drawing.Bitmap classes. A bitmap must be recreated based on another one and saved on the disk. Bitmap.GetPixel and Bitmap.SetPixel are enough in this case. However it should be aware that they work pretty slow. So in practice, it is preferred to use System.Runtime.InteropServices.Marshal.Copy instead. To answer questions in FIG. 9, testee needs to have knowledge in image editing and processing on top of C# array and operators.

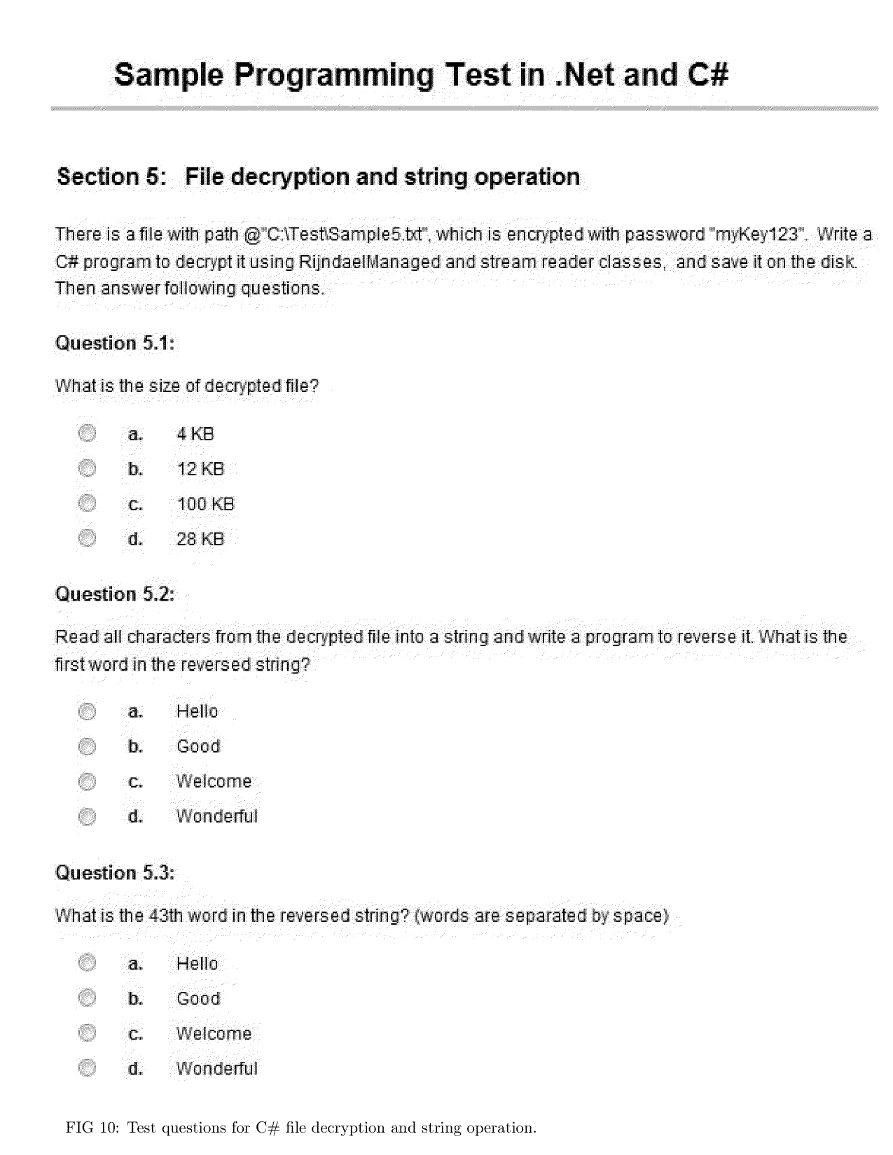

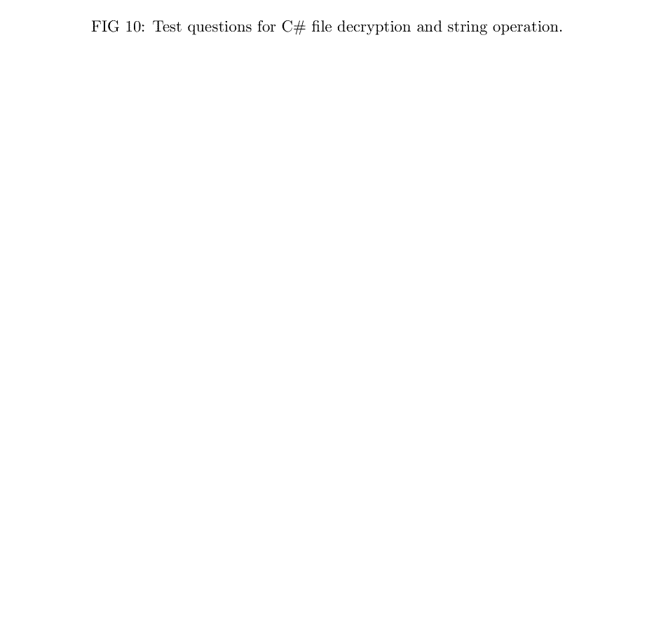

Questions in Section 5 test the programming skill in C# file decryption and string operation. To answer questions in FIG. 10, testee must be familiar with System.Security.Cryptography. RijndaelManaged, System.IO.FileStream and System.String classes. The file must be decrypted correctly and string must be converted in order to get answers right.

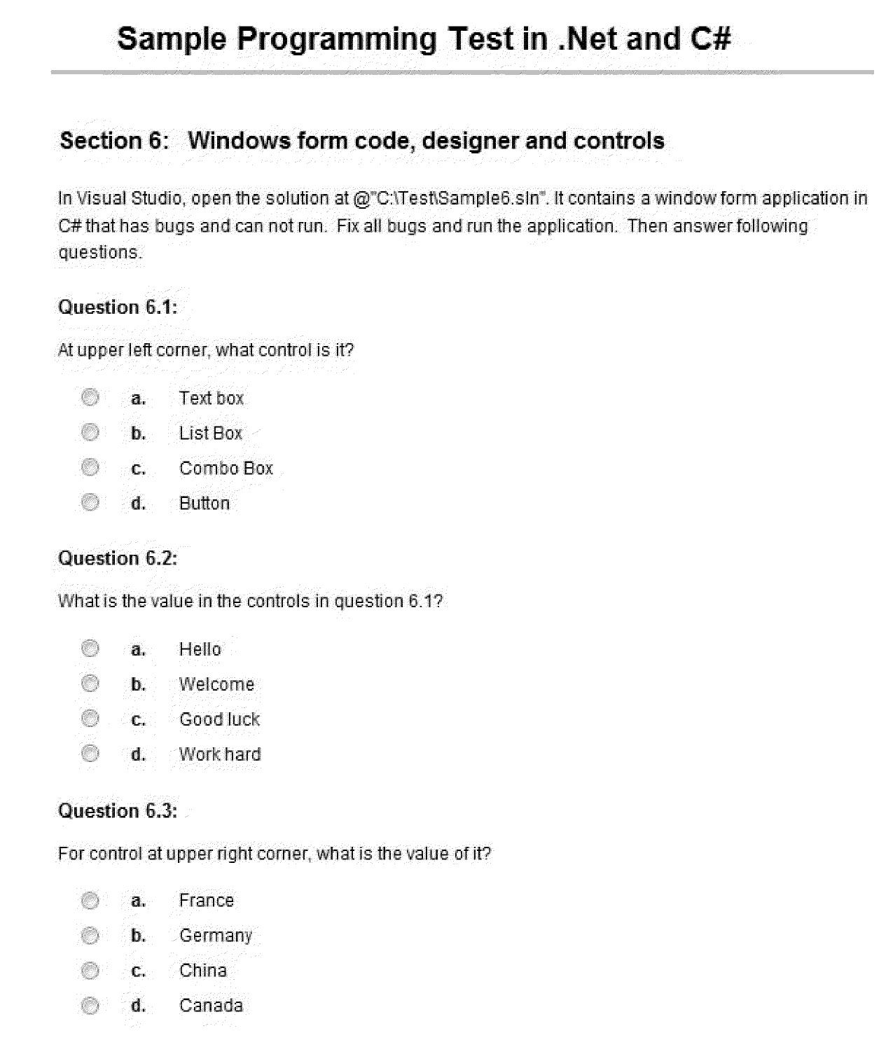

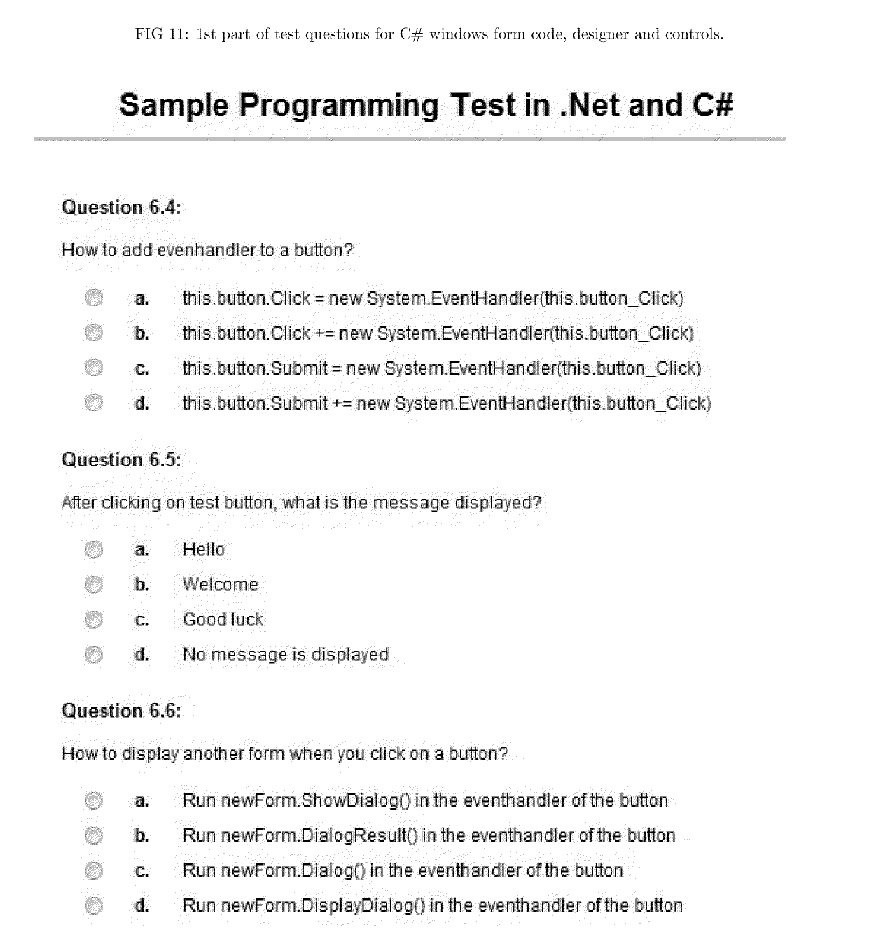

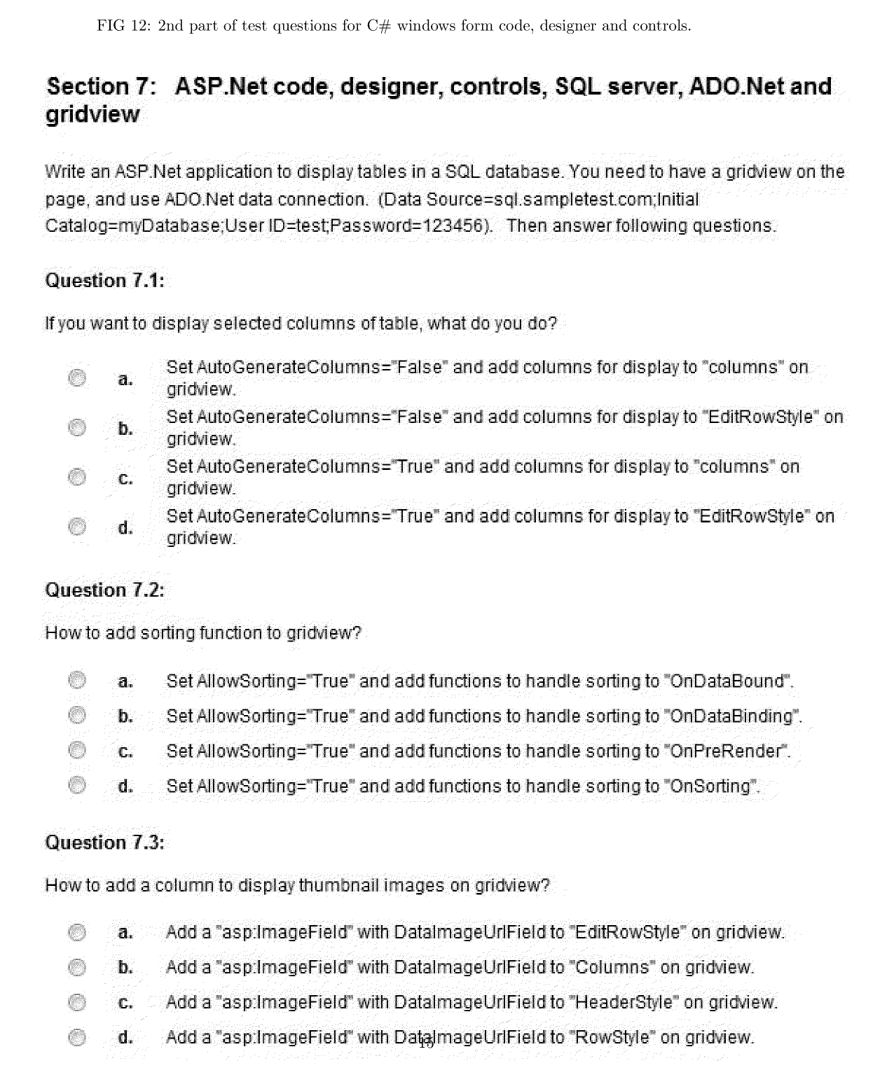

Questions in Section 6 test the programming skill in windows form code, designer and controls. Here bugs fixing scheme is adopted. A windows form project is already created but can not run. Testee must fix all the bugs in order to get the form running. Only after the form is running, messages in the various controls on the form can be identified. Here Properties.Settings.Default is used to set the values on the controls. To answer questions in FIGS. 11 and 12, testee must be familiar with windows form code, designer and controls, as well as must get the form running.

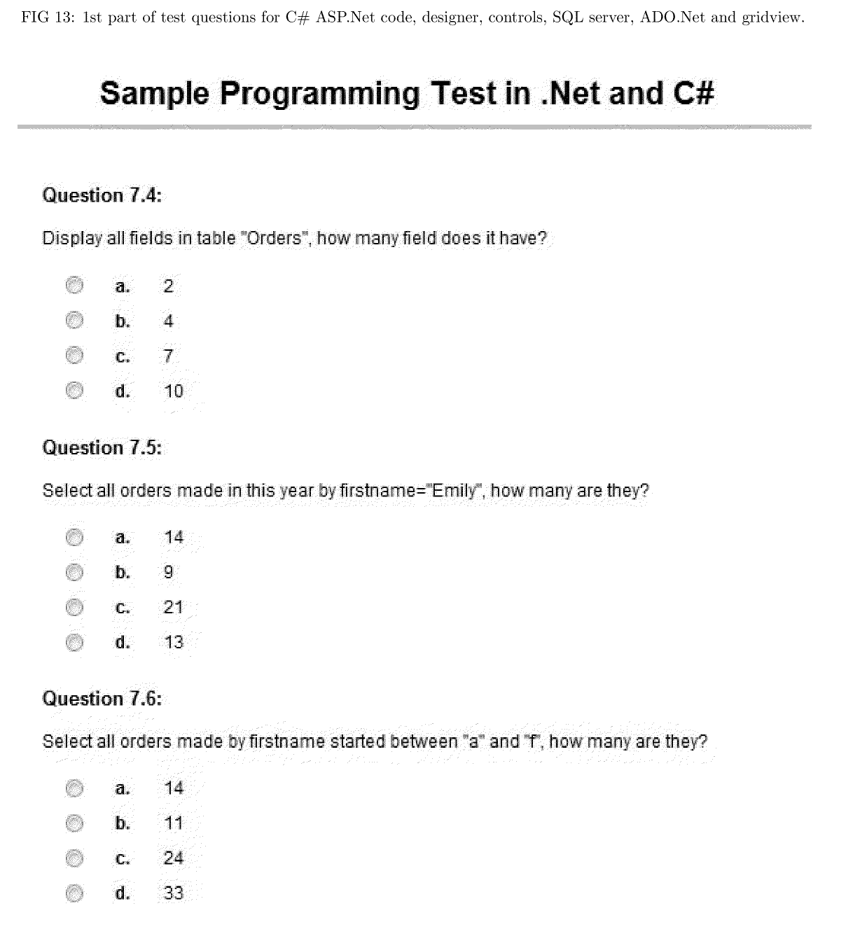

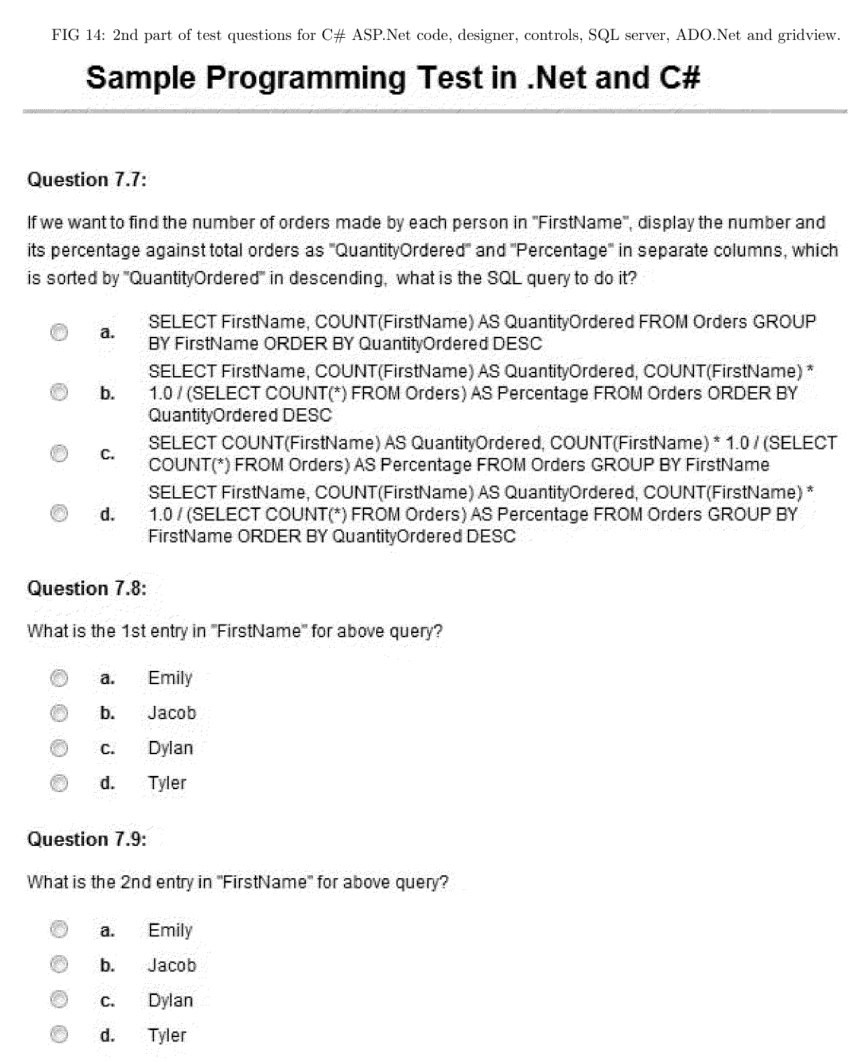

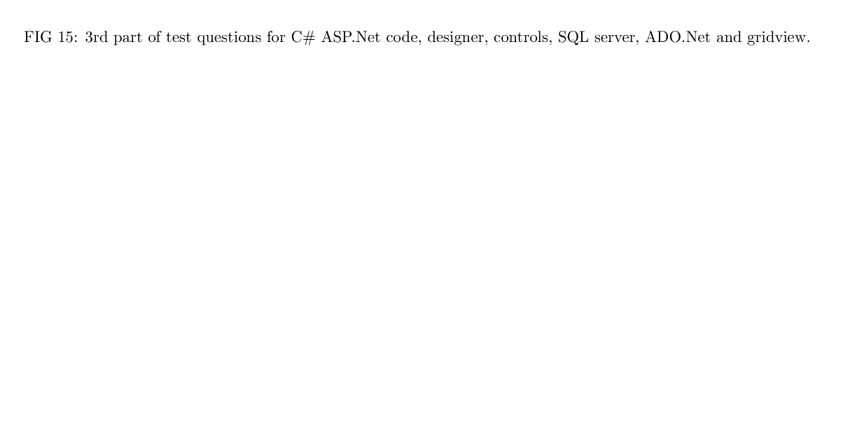

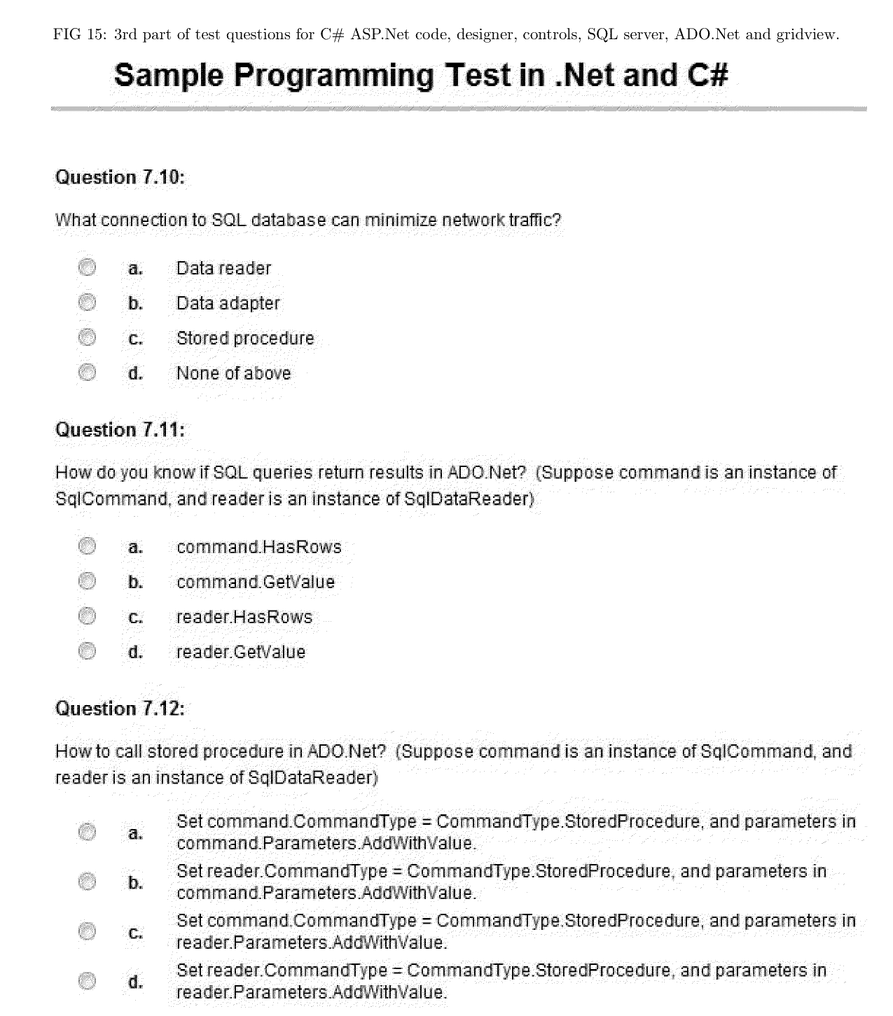

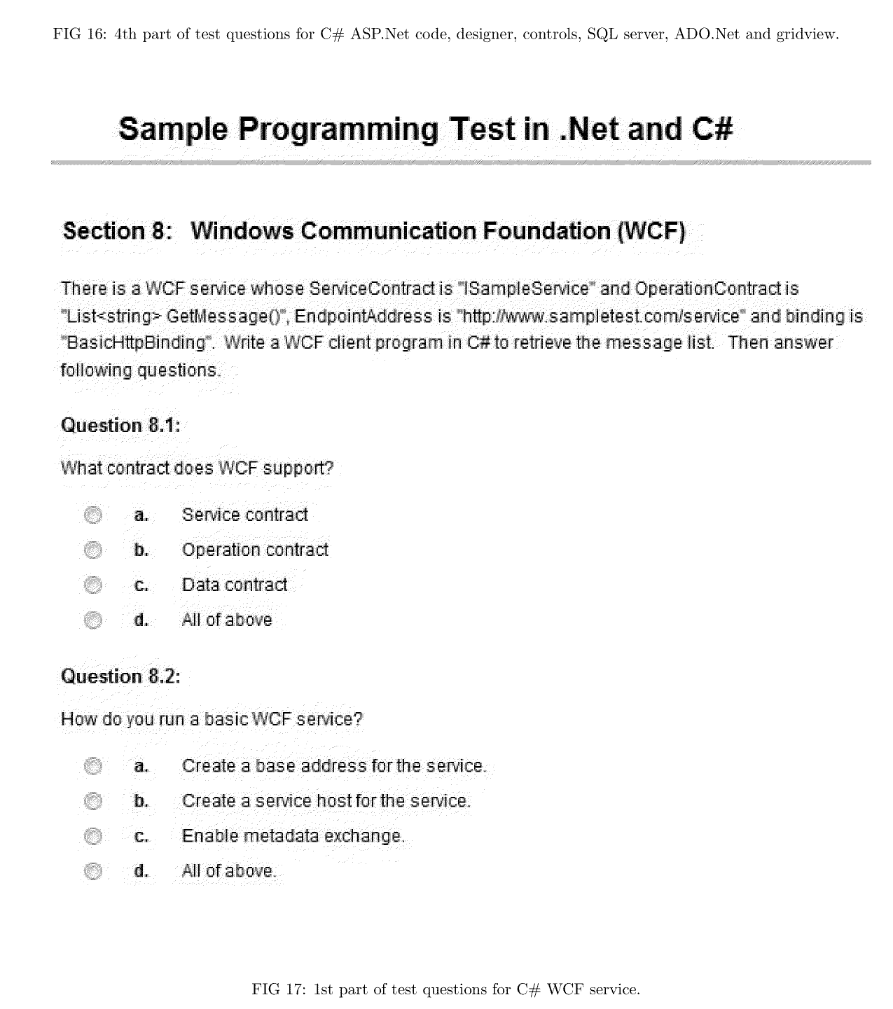

Questions in Section 7 test the programming skill in ASP.Net code, designer, controls, SQL server, ADO.Net and gridview. To answer questions in FIG. 13, testee must be familiar with ASP.Net code, designer, controls such as gridview. For questions in FIGS. 14,15 and 16, testee must be familiar with SQL server, queries, and ADO.Net. The query results from a SQL database table will be displayed in a gridview through ADO.Net data communication. Testee must have good knowledge and skill in ASP.Net controls such as gridview as well as SQL queries in order to answer the questions correctly.

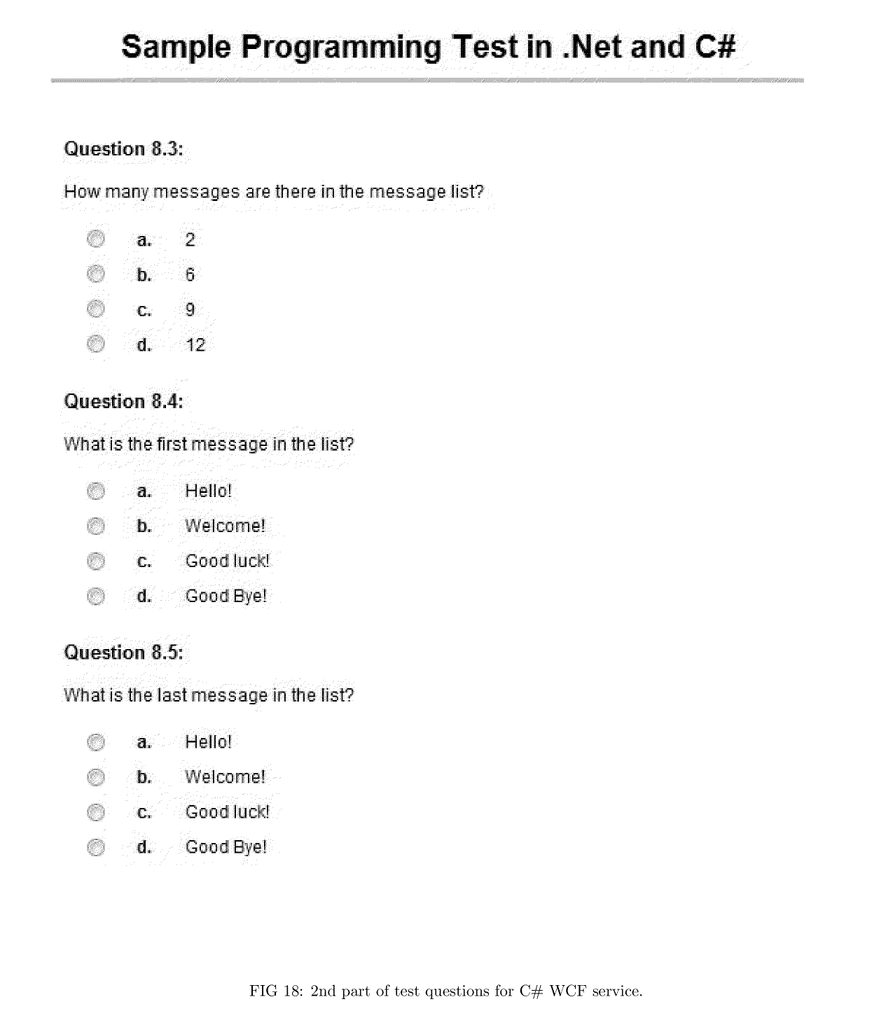

Questions in Section 8 test the programming skill in Windows Communication Foundation (WCF). To answer questions in FIGS. 17 and 18, testee must be familiar with WCF service and System.Collections.Generic.List class. A WCF client program is required to retrieve a generic list from WCF service in order to get answers right.

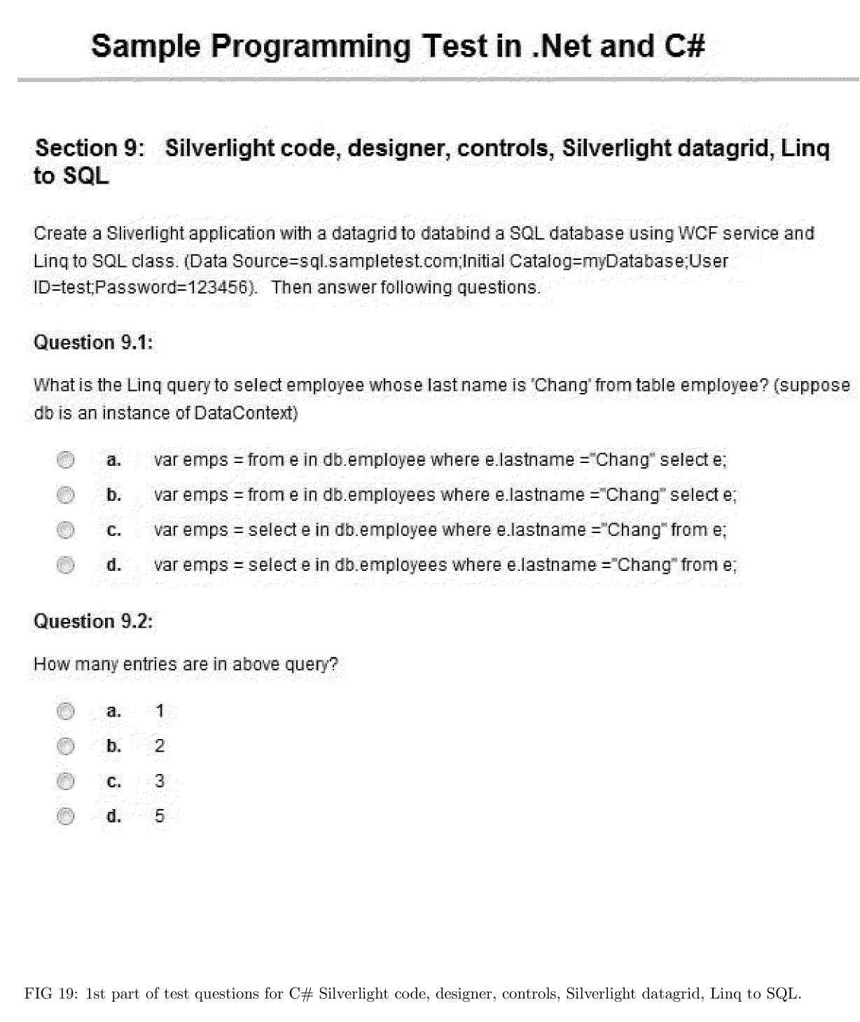

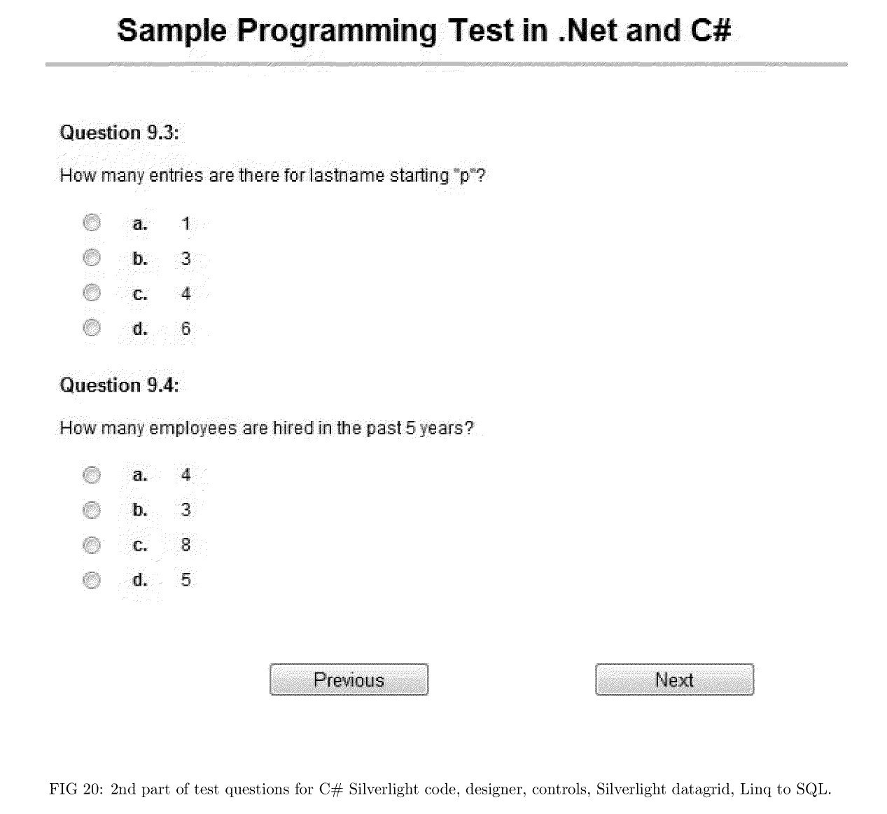

Questions in Section 9 test the programming skill in Silverlight code, designer, controls, Silverlight datagrid, Linq to SQL. To answer questions in FIGS. 19 and 20, testee must be familiar with Silverlight code, designer, controls and Linq. A Silverlight datagrid is needed to be created in Silverlight application and data binding is done through WCF service and Linq to SQL class. These together with right Linq queries are required to answer the question correctly.

Above descriptions illustrate how to design assessment test for programming skill in various areas of Microsoft .Net and C# programming language as the result of the embodiments of the invention. Testee must write actual programs and make them working correctly in order to answer questions right. All the questions in the test can be graded by machine without manual effort. It is clearly seen that questions in the test provide a better way for evaluating programming skill compared to other available tests. Further embodiments of the invention can be applied to design assessment tests for programming skill in other programming languages such as C, C++, Java, PHP and Objective-C.

What is claimed is:

1. A method to design assessment tests for computer programming skills, the method comprising:
allowing testee to do the actual programming in a specific programming language he takes the test, wherein the questions are designed in such a way that testee can only answer multiple choice questions correctly if he makes the computer programs running correctly, and thus the results can be graded by machine automatically without manual effort being involved; implementing tests for assessing programming skills in various fields of Microsoft .Net and C# programming language.

2. The implemented method of claim 1, wherein operators, array and stream reader class in C# are tested.

3. The implemented method of claim 1, wherein file, directory, and FTP classes in C# are tested.

4. The implemented method of claim 1, wherein HTTP and stream classes in C# are tested.

5. The implemented method of claim 1, wherein Image and Bitmap classes, image editing and saving, array and operators in C# are tested.

6. The implemented method of claim 1, wherein file decryption and string operation in C# are tested.

7. The implemented method of claim 1, wherein Windows form code, designer, and controls in C# are tested.

8. The implemented method of claim 1, wherein ASP.Net code, designer, controls, SQL server, ADO.Net and gridview in C# are tested.

9. The implemented method of claim 1, wherein WCF service in C# are tested.

10. The implemented method of claim 1, wherein Silverlight code, designer, controls, Silverlight datagrid and Linq to SQL in C# are tested.

11. The method of claims 1, further extending to test of Microsoft Visual Basic programming language.

12. The method of claims 1, further extending to tests of C and C++ programming languages.

13. The method of claims 1, further extending to tests of Java programming language.

14. The method of claims 1, further extending to tests of PHP programming language.

15. The method of claims 1, further extending to tests of Objective-C programming language.
